(19) United States
(12) Patent Application Publication
(10) Pub. No.: US 2011/0137817 A1
(43) Pub. Date: Jun. 9, 2011

(54) SYSTEM AND METHOD FOR AGGREGATING AND DISSEMINATING PERSONAL DATA

(75) Inventors: Tasos Roumeliotis, Orinda, CA (US); Scott Hotes, Berkeley, CA (US); Jacqueline Bernstein, San Francisco, CA (US)

(73) Assignee: Wavemarket, Inc., Emeryville, CA (US)

(21) Appl. No.: 12/791,854

(22) Filed: Jun. 1, 2010

Related U.S. Application Data
(60) Provisional application No. 61/217,321, filed on Jun. 1, 2009.

(51) Int. Cl. G06Q 99/00

(52) U.S. Cl. 705/325

(57) ABSTRACT

A computer-implemented method of aggregating and disseminating personal data is provided. The method includes establishing a user account for a user, wherein establishing the user account includes receiving identifying information of the user from the user. A user identifier is associated with the user account. A request for the user identifier is received from a remote application server, and an identifier request authorization is received from the user or the remote application server to provide the user identifier to the remote application server. The user identifier is provided to the remote application server in response to receiving the identifier request authorization. Personal data of a user associated with the user identifier is received from the user. A request for the personal data of the user associated with the user identifier is received from the remote application server. A data request authorization is received from the user to provide the user personal data, and the user personal data is provided to the remote application server in response to receiving the data request authorization. A system for aggregating and disseminating user personal data is further provided.

### CROSS REFERENCE TO RELATED APPLICATION(S)

This application claims the benefit of U.S. provisional application No. 61/217,321, filed Jun. 1, 2009, which is incorporated by reference as if fully set forth.

### BACKGROUND

There is a growing popularity of social networking websites and applications which share personal information among users. While a computer user may be interested in the offerings of one or more applications which permit sharing of personal information, that user may have reservations about allowing an application provider unabridged access to the user's personal information. Safety and privacy concerns may act to dissuade a potential consumer of such applications from using a particular application requiring user personal information, especially in the case where the personal data requiring application (hereinafter “personal applications”) is offered by a provider with which the consumer is unfamiliar.

Developers of applications may have their own reservations about expending the effort required to produce quality applications. Developers are often burdened by the complexity in designing applications which are capable of safeguarding personal information. It would be desirable to provide a system for aggregating and disseminating personal information which permits responses to personal information requests originating from a personal application server, the system addressing end user privacy concerns by controlling and limiting access to end user personal information by the personal application server without significantly diminishing the usability of the application. Such a system should facilitate the development and maintenance of personal applications by addressing issues of complexity in interacting with heterogeneous data sources.

### SUMMARY

The invention herein provides a computer-implemented method of aggregating and disseminating personal data. The method includes establishing a user account for a user, wherein establishing the user account includes receiving identifying information of the user from the user. A user identifier is associated with the user account. A request for the user identifier is received from a remote application server, and an identifier request authorization is received from the user or the remote application server to provide the user identifier to the remote application server. The user identifier is provided to the remote application server in response to receiving the identifier request authorization. Personal data of a user associated with the user identifier is received from the user. A request for the personal data of the user associated with the user identifier is received from the remote application server. A data request authorization is received from the user to provide the user personal data, and the user personal data is provided to the remote application server in response to receiving the data request authorization.

The invention further provides a system for aggregating and disseminating user personal data including a computing device including a memory comprising instructions operable to enable the computing device to perform a procedure. The procedure includes establishing a user account for a user, wherein establishing the user account includes receiving identifying information of the user from the user. A user identifier is associated with the user account. A request for the user identifier is received from a remote application server, and an identifier request authorization is received from the user or the remote application server to provide the user identifier to the remote application server. The user identifier is provided to the remote application server in response to receiving the identifier request authorization. Personal data of a user associated with the user identifier is received from the user. A request for the personal data of the user associated with the user identifier is received from the remote application server. A data request authorization is received from the user to provide the user personal data, and the user personal data is provided to the remote application server in response to receiving the data request authorization.

The invention further provides a system for aggregating and disseminating user personal data including a computing device, the computing device including a software architecture. The architecture includes a first application program interface (API) configured to associate a user identifier with a user account, receive from a remote application server a request for the user identifier, receive from at least one of a user and the remote application server an identifier request authorization, and provide the user identifier to the remote application server in response to receiving the identifier request authorization. The architecture further includes a second API configured to receive user personal data of a user associated with the user identifier from a remote telecommunication carrier server, receive from the remote application server a request for the user personal data, receive a data request authorization from the user, and provide the user personal data to the remote application server in response to receiving the data request authorization.

### BRIEF DESCRIPTION OF THE DRAWING(S)

The foregoing Summary as well as the following detailed description will be readily understood in conjunction with the appended drawings which illustrate preferred embodiments of the invention. In the drawings:

FIG. 1 is a schematic illustration of an exemplary operating environment in which a system for aggregating and disseminating personal information according to a preferred embodiment of the present invention is operable.

FIG. 2 is a flow chart showing a computer-implemented method of aggregating and disseminating personal information according to a preferred embodiment of the present invention.

FIG. 3 is a workflow diagram showing interactions between a user discovery application program interface (API) according to a preferred embodiment of the invention and a remote personal application server.

FIG. 4 is a workflow diagram showing interactions between a personal application program interface (API) according to a preferred embodiment of the invention and a remote personal application server.

FIG. 5 is a schematic illustration of another exemplary operating environment in which a system for aggregating and disseminating personal information according to a preferred embodiment of the present invention is operable.

### DETAILED DESCRIPTION OF THE PREFERRED EMBODIMENT(S)

The preferred embodiments of the present invention are described below with reference to the drawing figures where like numerals represent like elements throughout.

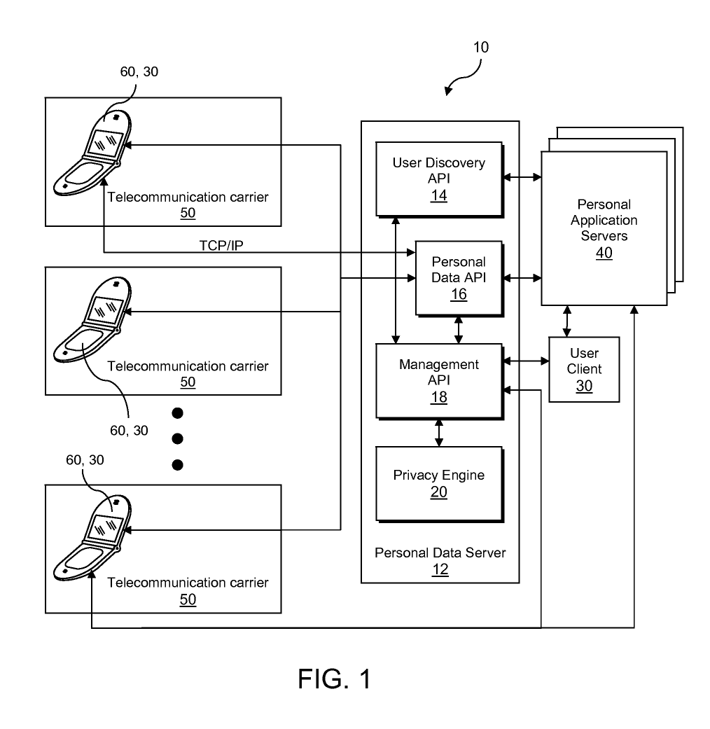

Referring to FIG. 1, a schematic illustration of an exemplary operating environment 10 is shown in which a preferred system for aggregating and disseminating personal information, in the form of a personal data server 12, may be used. The personal data server 12 includes one or more computing devices and one or more memory devices, which computing devices and memory devices may be integrally constructed or connected in any suitable manner, for example via a network. The personal data server 12 provides a platform which enables a user discovery application program interface (API) 14, a personal data API 16, a management API 18 and a privacy engine 20.

The management API 18 is configured to establish a user account using identifying information of a user. The personal data server 12 is configured to receive the identifying information through the management API 18 from a user client 30, such as a personal computer, mobile telephone device, or global positioning system (GPS) enabled device, via a network connection, which network connection is preferably an Internet network connection. The identifying information preferably includes at least the name of the user, an email address of a user, a telephone number associated with a user's mobile device, and a telecommunication carrier identifier associated with the user's mobile device used to establish a connection with the telecommunication carrier. The management API 18 preferably provides an interface through a client application running on the user client 30, which client application is preferably a web client, WAPclient, Java ME™ client, BREW™ client, SMS client or other suitable client. Alternatively, the personal data server 12 may be configured to receive the identifying information from the user client 30 through an interface provided by the user discovery API 14. The personal data server 12 associates a user identifier, which is preferably randomly generated, with the user account via a privacy engine 20.

The personal data server 12 is configured to receive from a remote personal application server 40 via the user discovery API 14 a request for the user identifier. The personal application server 40 is connected to the user clients 30 via a network and receives from the user clients 30 requests for services related to management and transfer of personal data. The services provided by the personal application server 40 preferably include providing personal information regarding a user of a mobile device 60 or other user client 30 to a another user or users of one or more other mobile devices 60 or user clients 30 based on preferences provided by the user. Services which support sharing of personal information among different users may include, or be delivered through applications compatible with or integral with, web-based social networking applications such as Facebook™, Yelp™, MySpace™, and Friendster™, or alternatively, through stand alone web-based or non-web-based applications.

The personal data server 12 is configured to receive via the user discovery API 14 an identifier request authorization, which, depending on the application provided by the personal application server 40 and the preference of the user, is received from either the user through the user client 30 or from the personal application server 40. In the case where the user provides the identifier request authorization, the connection between the personal application server 40 and the user client 30 is redirected to the user discovery API 14 by the personal application server 40, and after the personal data server 12 receives the identifier request authorization from the user client 30, the connection is redirected by the personal data server 12 back to the personal application server 40. In the case where the personal application server 40 provides the identifier request authorization, the identifier request authorization is preferably provided in the form of an element of known personal information from the user including but not limited to one or more of an email address, a physical address, and a telephone number associated with the user client 30. The personal data server 12 is configured to provide via the user discovery API 14 the user identifier to the personal application server 40 in response to receiving the identifier request authorization.

The personal data server 12 is configured to receive from a user client 30, which may be provided via a mobile device 60 or non-mobile device or system, via the personal data API 14, personal information of a user associated with the user identifier. The personal data server 12 is preferably configured to receive user personal information of the mobile device 60 or other user client 30 via TCP/IP communication protocol or through any suitable protocol through a telecommunication network. The a mobile device 60 or other user client 30 may further provide personal information to the personal data server 12 via a local client, for example a web, WAP, Java ME™, BREW™, SMS client on the mobile device 60.

The personal data server 12 is further configured to receive from the personal application server 40 via the personal data API 16 a request for the user personal data of the user mobile device 60 associated with the pre-determined user identifier. Prior to providing the user's personal data to the personal application server 40, a personal data request authorization must be received by the personal data server 12 via the personal data API 16 from the user through the user client 30, which as indicated above is preferably provided integral with the mobile device 60. To receive the personal data request authorization, the connection between the personal application server 40 and the user client 30 is redirected to the personal data API 16 by the personal application server 40. After the personal data server 12 receives the personal data request authorization from the user client 30, the connection is redirected by the personal data server 12 back to the personal application server 40. The personal data server 12 is configured to provide the user personal data to the personal application server 40 in response to receiving the personal data request authorization from the user client 30, and if personal data request authorization is not provided, no user personal information of the user is provided to the personal application server 40. The personal data request authorization may be received from the user client 30 as an authorization to provide user personal data at a specified level of detail or precision, one time, a predetermined number of times, for a specified time interval, until the authorization is revoked via the user client 30, or until any predetermined condition is met.

The personal data server 12 is configured to receive through the management API 18 an indication from the user of during which times the user personal data can be provided. Implementing the privacy engine 20, the personal data server 12 generates a database having a rules set based on the indication of the user. After receipt of the personal data request authorization from the user client 30, the personal data server 12 provides the user personal data to the personal application server 40 during the times indicated by the user as set forth in the rules set maintained by the privacy engine 20, and refrains from providing the user personal data to the personal application server 40 at all other times. Further, the personal data server 12 preferably can receive an indication from the user of a number of times or duration of time the user personal data may be provided to the personal application server 40 after receiving the personal data request authorization and prior to receiving an additional personal data request authorization. Alternatively, the personal data server 12 can receive an indication from the user that the user personal data may be provided to the personal application server 40 until such time as the user revokes authorization for the personal application server 40 to receive personal data.

The personal data server 12 is further configured to receive through the personal data API 16 indications from the personal application server 40 of at which times, with what frequency, and under what conditions the personal application server 40 requires the user personal data. The personal data server 12 provides the user personal data to the personal application server 40 at the times indicated, at the frequency indicated, and under the conditions specified by the personal application server 40 when or to the extent that such times, frequency, or conditions are not conflicting with indications received from the user. Accordingly, the personal data server 12 is configured to provide the user personal data to the personal application server 40 based on one or more indications from the personal application server 40 and one or more indications of the user. Preferably, the personal data server 12 provides the user personal data to the personal application server 40 in conformance with the one or more indications from the personal application server 40 to the extent that the one or more indications from the personal application server 40 do not conflict with the one or more indications of the user. As an example, if the personal application server 40 is running an application which requires for proper functionality to receive personal data generally continuously without reauthorizations after an initial user authorization, and the user requires reauthorization by the user each time personal data is requested by an personal application server 40 regardless of user preference, then the application cannot function and personal application server 40 can notify the user client 30 accordingly.

The personal data server 12 is configured to receive from the personal application servers 40 identifying information and to transmit the identifying information of the personal application servers 40 to the telecommunication carrier server 50. The identifying information of the personal application servers 40 preferably includes a publisher name or names of an application or applications running on the personal application servers 40. Alternatively, the identifying information can include any suitable information, including information useful for determining a level trustworthiness of the personal application servers 40. The personal data server 12 is further configured to transmit to the user through a user client 30 indications received from the personal application servers 40 of at which times, with what frequency, at what level of detail and under what conditions each of the personal application servers 40 require the user personal data. Based on the identifying information and/or the indications received from a particular personal application server 40, the user via a user client 30 can transmit to the personal data server 12 indications of at which times, with what frequency, at what level of detail and under what conditions user personal data can be provided to the particular personal application server 40 or a particular application running on the particular personal application server 40. In such a manner, a user can for different personal application servers 40 provide different indications of at which times, with what frequency, at what level of detail and under what conditions personal data can be provided. For example, a personal application server 40 considered to be trusted may be permitted to receive more detailed personal data of the user than a personal application server 40 considered to be non-trusted based on the identifying information of the personal application server 40.

The personal data server 12 preferably transmits to each personal application server 40 indications received from the user of at which times, with what frequency, under what conditions, and at what level of detail personal data can be provided to each personal application server 40. A personal application server 40 is therefore able to communicate to a user whether an application running on the personal application server 40 is compatible with the indications of the user associated with the user's client 30, for example whether the indications of the user are too restrictive to permit an application to function properly. Alternatively, the personal data server 12 can communicate to a user whether an application running on the personal application server 40 is compatible with the indications of the user with the user's client 30.

The personal data server 12 is further configured to receive from the personal application server 40 via the personal data API 16 a request for an authorization to provide the user personal data to a peer. The peer is preferably another user who uses the user personal data for interaction with an application running on the personal application server 60. Such application may include for example a game which requires users to exchange personal information in the process of playing the game. A permission is received by the personal data server 12 via the personal data API 16 from the user through the user client 30 to provide the user personal data to the peer. In response to the received permission, the personal data server 12 provides to the remote application server 40 the authorization to provide the user personal data to the peer.

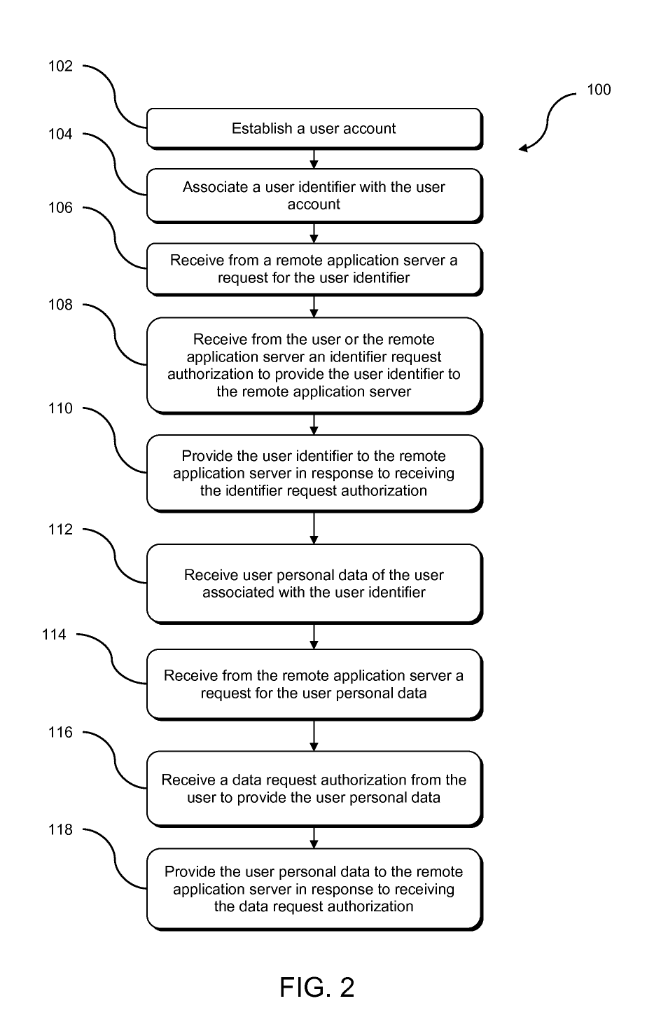

Referring to FIG. 2, a computer-implemented method 100 of aggregating and disseminating personal information according to a preferred embodiment of the present invention is shown. Such method is preferably implemented by the personal data server 12 shown in FIG. 1. Alternatively, any suitable computing system may be configured to implement the method 100. The method 100 includes establishing a user account (step 102) and associating a user identifier with the user account (step 104). A request for the user identifier is received from a remote application server (step 106). An identifier request authorization is received from the user or the remote application server to provide the user identifier to the remote application server (step 108). The user identifier is provided to the remote application server in response to receiving the identifier request authorization (step 110). Personal data of a user associated with the user identifier is received (step 112). A request for the user personal data of the user associated with the user identifier is received from the remote application server (step 114). A personal data request authorization is received from the user to provide the user personal data (step 116), and the user personal data is provided to the remote application server in response to receiving the data request authorization (step 118).

The personal data preferably includes an indication of a determined action and a duration or frequency of the determined action. The personal data can further include user age, gender, health and economic status, user web browsing history information, user data exchange history information. The method further alternatively includes receiving from another user a request for the user personal data and an indication of transferred value, and providing the user personal data to the another user via the remote application server in response to receiving the indication of transferred value and the request from the another user, in such manner the user can sell his or her personal data in view of such indication of transferred value.

The method further alternatively includes receiving from the user an indication of a plurality of users which are permitted to receive the user personal data via the remote application server and receiving from another user not included in the plurality of users a request for the user personal data, denying access of the another user to the user personal data, and transmitting a notification to the user of the request from the another user for the user personal data. In such manner the user can be notified of users who request personal data but who are not so authorized.

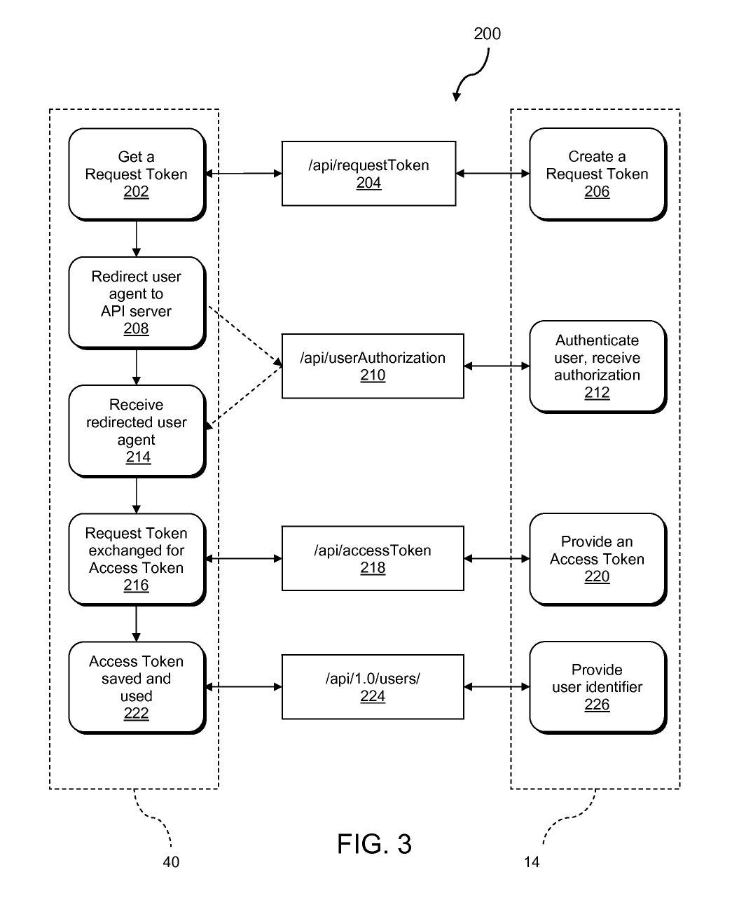

Referring to FIG. 3, a workflow 200 supported by the personal data server 12 and implemented by the user discovery API 14 according to the preferred embodiment of the present invention referred to in FIG. 1 is shown. The personal application server 40 directs a request for a request token (step 202) through a request token URL 204 provided by the user discovery API 14. The personal data server 12, via the user discovery API 14 creates a request token (step 206) which is provided to the personal application server 40 in response to the personal application server's request. If required by a user or a user's telecommunication carrier, or if necessitated by a particular application, a user agent is redirected by the personal application server 40 to the personal data server 12 (step 208) through a user authorization URL 210 provided by the user discovery API 14 which implements a suitable web interface or other interface to permit the user to enter required authorization. The personal data server 12, via the user discovery API 14 authenticates the user, shows the user the user's privacy settings, receives the identifier request authorization from the user, and redirects the user agent back to the personal application server 40 (step 212). The personal application server 40 receives the redirected user agent (step 214) and provides the request token, as associated with the identifier request authorization from the user, to the personal data server 12 through an access token URL 218 provided by the user discovery API 14 (step 216). The personal data server 12 provides an access token to the personal application server 40 in exchange for receiving the authorized request token (step 220). The personal application server 40 saves the access token and presents the access token to the personal data server 12 (step 222) through an identity URL 224, and the personal data server 12 provides the user identifier to the personal application server 40 in response to receiving the access token (step 226). The access token is preferably revoked immediately or within a predetermined time period after the user identifier is provided to the personal application server 40.

In the case where user authorization is not required as a prerequisite for providing the user identifier to the personal application server 40, for example in instances where a user has already provided identifying information to the personal application server 40, steps 202, 206, 208, 212, 214, 216 and 220 are omitted. In such case, the personal application server 40 preferably provides an application-specific access token in the step 222 which includes identifying information previously provided to the personal application server 40 by the user in order to retrieve the user's user identifier.

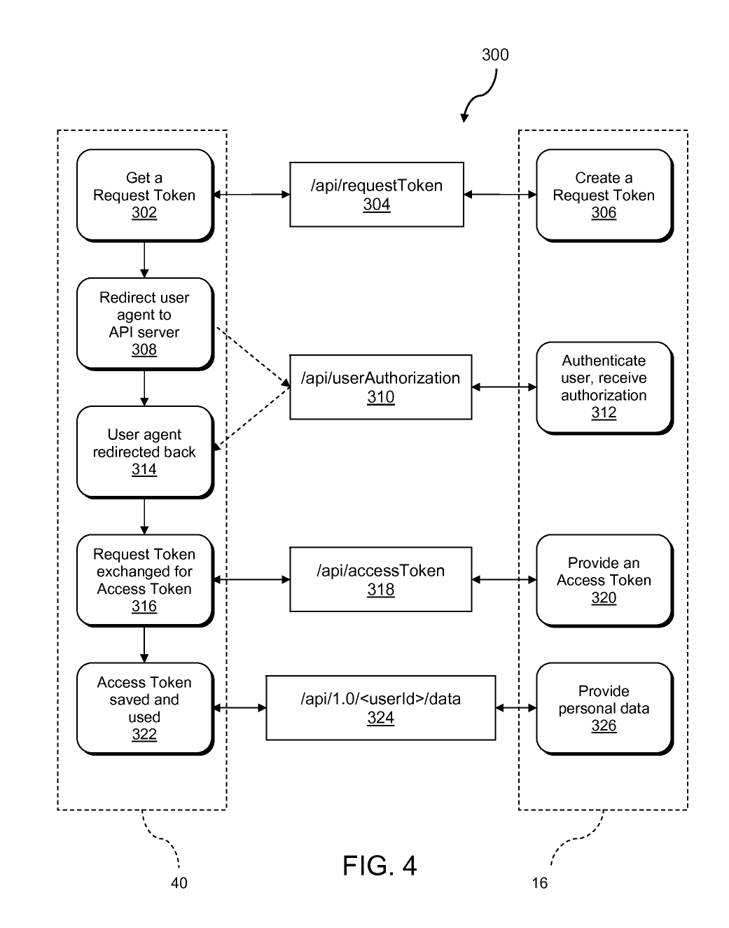

Referring to FIG. 4, a workflow 300, which preferably follows in time the workflow 200 of FIG. 3, supported by the personal data server 12 and implemented by the personal data API 16 according to the preferred embodiment of the present invention referred to in FIG. 1 is shown. The personal application server 40 directs a request for a request token (step 302), including the user identifier, through a request token URL 304 provided by the personal data API 16. The personal data server 12, via the personal data API 16 creates a request token (step 306) which is provided to the personal application server 40 in response to the personal application server's request. The user agent is redirected by the personal application server 40 to the personal data server 12 (step 308) through a user authorization URL 310 provided by the personal data API 16 which implements a suitable web interface or other interface to permit the user to enter required authorization. The personal data server 12, via the personal data API 16 authenticates the user, shows the user the user's privacy settings, receives the personal data request authorization from the user, and redirects the user agent back to the personal application server 40 (step 312). The personal application server 40 receives the redirected user agent (step 314) and provides the request token, as associated with the personal data request authorization from the user, to the personal data server 12 through an access token URL 318 provided by the personal data API 16 (step 316). The personal data server 12 provides an access token to the personal application server 40 in exchange for receiving the authorized request token (step 320). The personal application server 40 saves the access token and presents the access token to the personal data server 12 (step 322) through a data URL 324, and the personal data server 12 provides the user personal data, which may include new or updated personal data, to the personal application server 40 in response to receiving the access token (step 326). The access token is preferably revoked immediately or within a predetermined time period after the user personal data is provided to the personal application server 40.

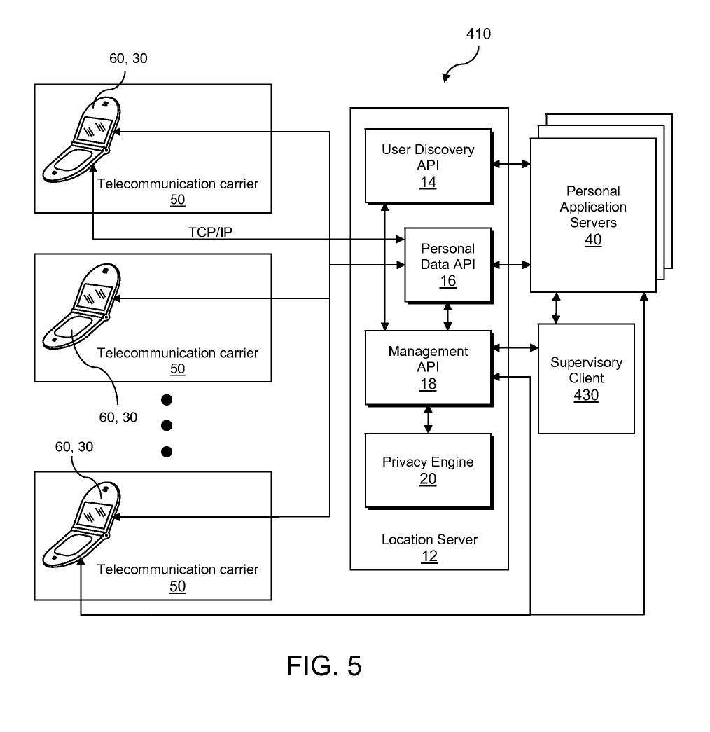

Referring to FIG. 5, a schematic illustration of another exemplary operating environment 410 is shown in which the personal data server 12 may be used. Within the operating environment 410, the personal data server 12 is configured to receive a permission from a supervisory user, preferably another user who is in a position of authority relative to the user of the user mobile device 60 or other user client 30, through a supervisory client 430 via the management API 18. The personal data server 12 is preferably configured to provide the user identifier to the personal application server 40 in response to receiving both the permission from the supervisory client 430 and the identifier request authorization from the user client 30 or the personal application server 40 as described above. The personal data server 12 is preferably further configured to provide the user personal data to the personal application server 40 in response to receiving both the permission from the supervisory client 430 and the personal data request authorization from the user client 30. Accordingly, the personal data server 12 must receive the permission from the supervisory client 430, the identifier request authorization, and the personal data request authorization prior to providing the user personal data to the personal application server 40.

The personal data server 12 through the management API 18 transmits a request to the supervisory client 430 to provide the permission for a particular personal application server 40 in response to receiving the identifier request authorization from the user client 30 or the personal application server 40, or in response to receiving the personal data request authorization from the user client 30. Alternatively, the personal data server 12 transmits the request to the supervisory client 430 to provide the permission in response to receiving any suitable indication from the user client 30 that the supervised user desires to provide user personal data to a particular personal application server 40. In this manner, a parent or other person or entity in a supervisory role over a supervised user may exercise control over which personal application servers 40 have access to the supervised user's personal data, and consequently, what types of personal applications the supervised user may use. Preferably, after the personal data server 12 receives the identifier request authorization, personal data request authorization or other suitable indication from the user client 30 that the user desires to provide personal data to a particular personal application server 40, the personal data API 16 enters a pending status until such time as the permission is received from the supervisory client 430. If the permission is not received from the supervisory client 430 within a predetermined period of time or if an indication is received from the supervisory client 430 that a permission is denied, the personal data server 12 ceases acceptance of a permission from the supervisory client 430 and transmits an indication of a denial to the user client 30 via the management API 18. The supervisory user through the supervisory client 430 is preferably required to provide login credentials to the management API 18 prior to providing the permission or providing an indication that an indication is denied.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A computer-implemented method of aggregating and disseminating personal data comprising:
establishing a user account for a user, wherein establishing the user account comprises receiving identifying information of the user from the user;
associating a user identifier with the user account;
receiving from a remote application server a request for the user identifier;
receiving from at least one of the user and the remote application server an identifier request authorization to provide the user identifier to the remote application server;
providing the user identifier to the remote application server in response to receiving the identifier request authorization;
receiving user personal data of the user associated with the user identifier;
receiving from the remote application server a request for the user personal data associated with the user identifier;
receiving a data request authorization from the user to provide the user personal data; and
providing the user personal data to the remote application server in response to receiving the data request authorization.

2. The computer-implemented method of claim 1, wherein the establishing the user account comprises receiving a name of the user, receiving a telephone number of the user, and receiving a telecommunication carrier identifier.

3. The computer-implemented method of claim 1, wherein the associating the user identifier with the user account comprises associating a unique user identifier with the user account.

4. The computer-implemented method of claim 1, further comprising:
connecting to a user mobile device associated with the user through a redirection from the remote application server and receiving the identifier request authorization from the user through the connection to the user mobile device; and
redirecting the user mobile device connection to the remote application server.

5. The computer-implemented method of claim 1, further comprising:
connecting to a user mobile device through a redirection from the remote application server and receiving the data request authorization from the user through the connection to the user mobile device; and
redirecting the user mobile device connection to the remote application server.

6. The computer-implemented method of claim 1, wherein:
receiving the user personal data comprises receiving at least one indication of a determined action; and
providing the user personal data comprises providing the at least one indication of the determined action to the remote application server.

7. The computer-implemented method of claim 1, wherein:
receiving the user personal data comprises receiving at least one indication of a determined action and a duration of the determined action; and
providing the user personal data comprises providing the at least one indication of the determined action and the duration of the determined action.

8. The computer-implemented method of claim 1, wherein:
receiving the user personal data comprises receiving at least one indication of a determined action and a frequency of the determined action; and
providing the user personal data comprises providing the at least one indication of the determined action and the frequency of the determined action.

9. The computer implemented method of claim 1, wherein:
receiving the user personal data comprises receiving at least one of user age, gender, health and economic status; and
providing the user personal data comprises providing the at least one of the user age, gender, health and economic status.

10. The computer implemented method of claim 1, wherein:
receiving the user personal data comprises receiving user web browsing history information; and
providing the user personal data comprises providing the user web browsing history information.

11. The computer implemented method of claim 1, wherein:
receiving the user personal data comprises receiving user data exchange history information; and
providing the user personal data comprises providing the user data exchange history information.

12. The computer implemented method of claim 1, wherein:
receiving the user personal data comprises receiving user communication history information; and
providing the user personal data comprises providing the user communication history information.

13. The computer implemented method of claim 1, further comprising:
receiving from another user a request for the user personal data; and
providing the user personal data to the another user via the remote application server.

14. The computer implemented method of claim 1, further comprising:
receiving from another user a request for the user personal data and an indication of transferred value; and
providing the user personal data to the another user via the remote application server in response to receiving the indication of transferred value and the request from the another user.

15. The computer implemented method of claim 1, further comprising:
receiving from the user an indication of a plurality of users which are permitted to receive the user personal data via the remote application server;
receiving from another user not included in the plurality of users a request for the user personal data;
denying access of the another user to the user personal data; and
transmitting a notification to the user of the request from the another user for the user personal data.

16. The computer implemented method of claim 1, further comprising:
receiving from the user an indication of a plurality of users which are not permitted to receive the user personal data via the remote application server;
receiving from at least one of the plurality of users a request for the user personal data;
denying access of the at least one of the plurality of users to the user personal data; and
transmitting a notification to the user of the request from the at least one of the plurality of users for the user personal data.

17. The computer-implemented method of claim 1, further comprising:
receiving an indication from the user of a number of times the user personal data may be provided to the remote application server after receiving the data request authorization and prior to receiving an additional data request authorization; and
providing the user personal data to the remote application server the number of times indicated by the user.

18. The computer-implemented method of claim 1, further comprising:
receiving an indication from the remote application server of with what frequency the remote application server requires the user personal data; and
providing the user personal data to the remote application server at the frequency indicated by the remote application server.

19. The computer-implemented method of claim 1, further comprising:
providing a request token to the remote application server;
associating the user identifier request authorization with the request token to authorize the request token;
receiving the authorized request token from the remote application server;
providing an access token to the remote application server in response to receiving the request token;
receiving the access token from the remote application server; and
providing the user identifier to the remote application server in response to receiving the access token.

20. The computer-implemented method of claim 1, further comprising:
providing a request token to the remote application server in response to receiving the user identifier;
connecting to a user device through a redirection from the remote application server and receiving the data request authorization from the user through the connection to the user device;
redirecting the connection to the user device to the remote application server;
associating the data request authorization with the request token to authorize the request token;
receiving the authorized request token from the remote application server;
providing an access token to the remote application server in response to receiving the authorized request token;
receiving the access token from the remote application server; and
providing the user personal data to the remote application server in response to receiving the access token.

21. The computer-implemented method of claim 1, further comprising:
receiving the request for the user identifier via a first application program interface (API);
receiving the user personal data via a second API; and
receiving the request for the user personal data from the second API.

22. The computer-implemented method of claim 1, further comprising:
providing at least one of a web interface and a WAP interface; and
receiving at least one of the identifier request authorization and the data request authorization through the at least one of the web interface and the WAP interface.

23. The computer-implemented method of claim 1, further comprising querying at predetermined intervals at least one of a user device associated with the user and a remote telecommunication carrier server to transmit the user personal data of the user device.

24. The computer-implemented method of claim 1, further comprising:
receiving from another user a permission; and
providing the user personal data to the remote application server in response to receiving the permission of the another user.

25. The computer-implemented method of claim 1, further comprising:
receiving an indication from the user to provide the user personal data to the remote application server;
transmitting a request to another user to generate a permission to transmit the user personal data to the remote application server;
receiving from the another user the permission to provide the user personal data to the remote application server; and
providing the user personal data to the remote application server in response to receiving the permission of the another user.

26. The computer-implemented method of claim 1, further comprising receiving the user personal data at predetermined time intervals.

27. The computer-implemented method of claim 1, further comprising:
receiving from the remote application server a request for an authorization to provide the user personal data to a peer;
receiving from the user a permission to provide the user personal data to the peer; and
providing to the remote application server the authorization to provide the user personal data to the peer in response to receiving the permission from the user.

28. A system for aggregating and disseminating user personal data comprising at least one computing device including at least one memory comprising instructions operable to enable the computing device to perform a procedure comprising:
establishing a user account for a user, wherein establishing the user account comprises receiving identifying information of the user from the user;
associating a user identifier with the user account;
receiving from at least one remote application server a request for the user identifier;
receiving from at least one of the user and the at least one remote application server an identifier request authorization to provide the user identifier to the at least one remote application server;
providing the user identifier to the at least one remote application server in response to receiving the identifier request authorization;
receiving user personal data of a user associated with the user identifier;
receiving from the at least one remote application server a request for the user personal data of the user associated with the user identifier;
receiving a data request authorization from the user to provide the user personal data; and
providing the user personal data to the at least one remote application server in response to receiving the data request authorization.

29. The system of claim 28, wherein the memory further comprises instructions operable to enable the computing device to:
receive from the user at least one indication of another user which is not permitted to receive the user personal data via the remote application server; and
deny access of the another user to the user personal data.

30. The system of claim 28, wherein the memory further comprises instructions operable to enable the computing device to:
receive from the user an indication of a plurality of users which are permitted to receive the user personal data via the remote application server;
provide the user personal data to the plurality of permitted users via the remote application server; and
deny access of at least one other user not indicated in the indication of the plurality of users.

31. A system for aggregating and disseminating user personal data comprising at least one computing device, the at least one computing device comprises a software architecture comprising:
a first application program interface (API) configured to associate a user identifier with a user account, receive from a remote application server a request for the user identifier, receive from at least one of a user and the remote application server an identifier request authorization, and provide the user identifier to the remote application server in response to receiving the identifier request authorization; and
a second API configured to receive user personal data of a user associated with the user identifier from a remote telecommunication carrier server, receive from the remote application server a request for the user personal data, receive a data request authorization from the user, and provide the user personal data to the remote application server in response to receiving the data request authorization.

32. The system of claim 31, wherein the software architecture of the at least one computing device further comprises a privacy engine configured to generate a rules set based on at least one indication of the user and configured to provide the user personal data to the remote application server according to the rules set indicated by the user.
